(19) United States
(12) Patent Application Publication
(10) Pub. No.: US 2026/0230853 A1
(43) Pub. Date: Aug. 6, 2026

(54) System and Method for Configuring A Transceiver for a Bluetooth Connection

(71) Applicant: Bayerische Motoren Werke Aktiengesellschaft, Muenchen (DE)

(72) Inventors: Thomas Wursthorn, Muenchen (DE); Atanas Lyutskanov, Muenchen (DE)

(21) Appl. No.: 19/150,756

(22) PCT Filed: Oct. 9, 2023
(86) PCT No.: PCT/EP2023/077835

§ 371 Date: Jul. 24, 2025

(30) Foreign Application Priority Data
Feb. 1, 2023 (DE) 10 2023 102 449.3

(51) Int. Cl. H04W 24/02; H04W 48/02; H04W 76/20; H04W 76/30

(52) U.S. Cl. CPC H04W 24/02; H04W 48/02; H04W 76/20; H04W 76/30

(57) ABSTRACT

A method for configuring one of a plurality of transceivers for a Bluetooth connection is disclosed herein. The method includes receiving priority information indicating a priority of a user terminal. The method also includes determining, based on the priority information, a transceiver of the plurality of transceivers for communicating with the user terminal using a Bluetooth connection. The method further includes determining a configuration parameter for the transceiver, and controlling a configuration of the transceiver based on the configuration parameter.

### CROSS-REFERENCE TO RELATED APPLICATIONS

The present application is the U.S. national phase of PCT Application PCT/EP2023/077835 filed on Oct. 9, 2023, which claims priority of German patent application No. 10 2023 102 449.3 filed on Feb. 1, 2023, the entire contents of which are incorporated herein by reference.

### FIELD

Embodiments of the present disclosure relate to a method for configuring a transceiver for a Bluetooth connection, a method for a transceiver, a computer program, a device and a vehicle, wherein the method includes configuring a transceiver based on a configuration parameter.

### BACKGROUND

If a plurality of Bluetooth Low Energy (BLE) transceivers are communicatively coupled to a central control unit, the individual BLE transceivers of the plurality of BLE transceivers can use the same identifier. This means that a communication device that connects to one of the BLE transceivers cannot distinguish between the individual BLE transceivers. For example, a communication device may connect to a BLE transceiver from which a signal was first received. This may result in a BLE transceiver being connected to a plurality of communication devices and a connection to a new communication device being no longer possible. This can adversely affect the establishment of a connection between a BLE transceiver and a communication device.

There is therefore a need to provide an improved method for configuring a transceiver for a Bluetooth connection.

### SUMMARY

Exemplary embodiments are based on the core idea that a method for configuring a transceiver for a Bluetooth connection can be carried out based on priority information. This allows a communications device to set up an appropriate connection to the transceiver.

Exemplary embodiments relate to a method for configuring a transceiver for a Bluetooth connection. The method comprises receiving priority information indicating a priority of a user terminal. Further, the method comprises determining a transceiver for communication by means of a Bluetooth connection to the user terminal, based on the priority information. The method also comprises determining a configuration parameter for the transceiver and controlling a configuration of the transceiver based on the configuration parameter. By using the priority information, a configuration of the transceiver can be adapted in such a way that a user terminal with a high priority can establish a required Bluetooth connection. For example, the bandwidth of the Bluetooth connection can be adjusted, for example, by terminating a connection to another user terminal. For example, the user terminal can be the only user terminal to maintain/establish a connection to the transceiver.

In one exemplary embodiment, the determination of the configuration parameter can comprise terminating an active Bluetooth connection between the transceiver and a further user terminal with a lower priority than the user terminal, preventing a Bluetooth connection from being set up between a further user terminal and the transceiver, terminating an active Bluetooth connection between the user terminal and a further transceiver, and/or maintaining or establishing a Bluetooth connection between the transceiver and the user terminal. This allows a parameter of the Bluetooth connection, such as a bandwidth, to be controlled. For example, a bandwidth for the user terminal can be increased by terminating an active Bluetooth connection between the transceiver and a further user terminal.

In one exemplary embodiment, the method can further comprise determining the priority of the user terminal based on the priority information. The priority can be determined by the transceiver and/or by a central control unit which is communicatively connected to the transceiver. For example, the central control unit may have received a plurality of priority information items from individual user terminals connected to the transceiver. Based on the plurality of priority information items, a priority (in particular in relation to the other user terminal) can then be determined for each user terminal. This can improve the determination of the priority of a user terminal.

In one exemplary embodiment, the method can further comprise assigning a further transceiver for a further user terminal. For example, a further user terminal, the Bluetooth connection of which to the transceiver has been terminated, can establish a new Bluetooth connection to the further transceiver. This allows an advantageous assignment of individual user terminals to a plurality of transceivers.

In one exemplary embodiment the priority of the user terminal can depend on a: required parameter of the Bluetooth connection between user terminal and transceiver to perform a function. This allows the Bluetooth connection to be adapted to the requirements of the user terminal. For example, a required bandwidth cannot be made available to a user terminal because another user terminal with a comparable priority prevents this. Accordingly, the priority of the user terminal can be adapted to suit available resources.

In one exemplary embodiment the control can comprise sending the configuration parameter to the transceiver. This allows the transceiver to receive the configuration parameter from an external unit, such as a central control unit. For example, a central control unit can manage a plurality of transceivers.

Exemplary embodiments relate to a method for a transceiver for configuring the transceiver for a Bluetooth connection. The method comprises receiving, from a user terminal, priority information indicating a priority of a user terminal. Furthermore, the method comprises sending the priority information to a central control unit. Further, the method comprises receiving, from the central control unit, a configuration parameter for the transceiver and setting a configuration of the transceiver based on the configuration parameter. This allows the transceiver to receive a configuration for a Bluetooth connection to the user terminal from the central control unit.

Exemplary embodiments also provide a computer program for implementing a method described herein, when the computer program is executed on a computer, a processor or programmable hardware component.

A further exemplary embodiment is a device for configuring a transceiver for a Bluetooth connection. The device comprises an interface for communication with other communication devices (e.g., a user terminal, a central control unit and/or a transceiver), and a data processing circuit which is designed for carrying out at least one of the methods described herein. In addition, exemplary embodiments provide a vehicle having a device as described herein.

### BRIEF DESCRIPTION OF THE DRAWINGS

Exemplary embodiments will be explained below with reference to the accompanying drawings. In the drawings:

FIG. 1 shows a schematic representation of a method for configuring a transceiver for a Bluetooth connection;

FIG. 2 shows a schematic representation of a method for a transceiver for configuring the transceiver for a Bluetooth connection; and

FIG. 3 shows a block diagram of an exemplary embodiment of a device, for example for a vehicle.

Various exemplary embodiments will now be described in more detail with reference to the accompanying drawings, in which several exemplary embodiments are shown. In the figures, the thickness dimensions of lines, layers and/or regions are shown exaggerated for the sake of clarity.

### DESCRIPTION

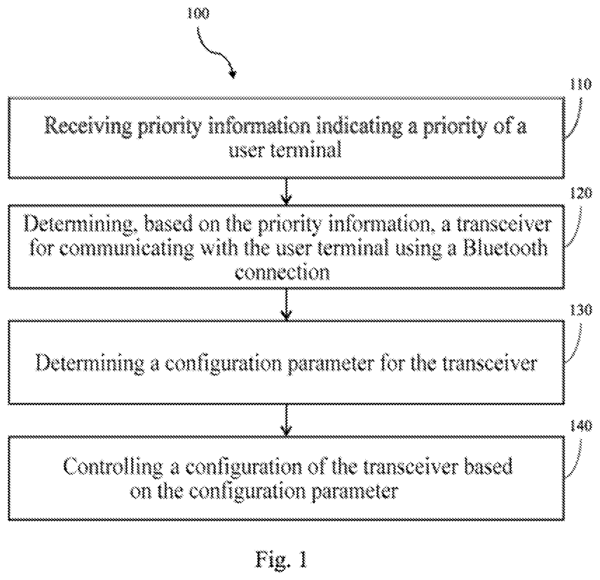

FIG. 1 shows a schematic representation of a method 100 for configuring a transceiver for a Bluetooth connection. The method 100 comprises receiving 110 priority information indicating a priority of a user terminal. The priority information can be received from the user terminal or the transceiver. For example, the method 100 can be carried out by a central control unit which is communicatively connected to the transceiver. The central control unit can then receive the priority information from the transceiver. Alternatively, the method can be carried out by the transceiver itself. The transceiver can receive the priority information from the user terminal.

Further, the method 100 comprises determining 120 a transceiver for communication by means of a Bluetooth connection to the user terminal, based on the priority information. For example, for a user terminal with a high priority, a transceiver can be determined which enables an optimal Bluetooth connection to the user terminal. Alternatively, for a lower-priority user terminal, transceiver can be determined which does not allow an optimal Bluetooth connection to the user terminal. This allows resources to be advantageously distributed. For example, a priority of the user terminal may depend on an application of the user terminal to be executed.

Furthermore, the method 100 comprises determining 120 a configuration parameter for the transceiver. The configuration parameter can indicate a transceiver configuration. For example, a configuration of the transceiver can only allow one Bluetooth connection, or an establishment of the Bluetooth connection, to the user terminal. This allows the transceiver to be configured exclusively for the user terminal.

For example, a high-priority Bluetooth connection (for example, to a user terminal with a high priority) can be assigned to a particular transceiver, a low-priority Bluetooth connection (for example to a user terminal with a low priority) can be moved from the transceiver to another transceiver (in particular if the transceiver has established a high-priority Bluetooth connection), and/or the transceiver can be blocked for the establishment of new Bluetooth connections (in particular to further, low-priority, user terminals).

Furthermore, the method 100 comprises controlling 140 a configuration of the transceiver based on the configuration parameter. The control 140 can be carried out, for example, by sending the configuration parameter from the central control unit to the transceiver. The central control unit can control a configuration of the transceiver. Alternatively, the transceiver can determine the configuration parameter and control its own configuration, for example by adjusting the configuration.

By controlling 140 the configuration of the transceiver, a Bluetooth connection can be adapted to necessary or desired parameters. In particular, the ability to perform a function and/or a service that is performed by the user terminal can be improved.

For example, a function that is activated from the user terminal may require a permanent data exchange with the transceiver (for example, for remote parking). A function with permanent data exchange can have a higher priority, i.e. a function with a high priority. Accordingly, a higher priority can be assigned to a user terminal that performs a high-priority function. For example, the priority information may comprise information about a function of the user terminal to be performed. This allows the central control unit or the transceiver to determine a priority, for example based on the function to be performed.

A high-priority function can be performed on a dedicated Bluetooth connection. At the start time of the activation, the target device, i.e. the user terminal, may already be known and have established a Bluetooth connection to the transceiver.

To ensure exclusivity of the transceiver for the high-priority function, the central control unit or the transceiver can turn off Bluetooth advertising on or of the transceiver. As a result, other user terminals cannot detect the transceiver. In particular, a new Bluetooth connection to another user terminal can be prevented. Optionally, all other user terminals that have already established a Bluetooth connection to the transceiver can be disconnected from the transceiver. In particular, additional user terminals with lower priority can be disconnected.

The disconnection can be based on the high-priority function. For example, disconnecting the Bluetooth connection to the low-priority user terminal can take place immediately or after completion of a currently running application-based communication to perform the high-priority function. If a low-priority further user terminal is disconnected, it can connect to another transceiver and/or carry out a handover in accordance with the standards of the Car Connectivity Consortium.

In one exemplary embodiment, the determination of the configuration parameter can comprise terminating an active Bluetooth connection between the transceiver and a further user terminal with a lower priority than the user terminal, preventing a Bluetooth connection from being set up between a further user terminal and the transceiver, terminating an active Bluetooth connection between the user terminal and a further transceiver, and/or maintaining or establishing a Bluetooth connection between the transceiver and the user terminal. For example, terminating an active Bluetooth connection between the transceiver and the further user terminal allows the bandwidth of the Bluetooth connection for the user terminal to be increased. Preventing a Bluetooth connection from being set up can be achieved, for example, by disabling Bluetooth advertising of the transceiver. Furthermore, an active Bluetooth connection between the user terminal and a further transceiver can be terminated in order to establish a Bluetooth connection between the transceiver and the user terminal. This allows the user terminal to be assigned to a suitable transceiver. In particular, assignment to a transceiver can improve the execution of a high-priority function.

In one exemplary embodiment, the method can further comprise determining the priority of the user terminal based on the priority information. The priority information may comprise, for example, information about a function to be performed, identification of the user terminal, or a priority of the user terminal. For example, the user terminal may have a high priority, for example, perform a high-priority function. The user terminal can then send priority information that includes the priority of the user terminal. The central control unit or the transceiver can thus receive the priority of the user terminal from the user terminal.

Alternatively, the priority can be determined by the central control unit or the transceiver. For example, the priority information may include information about the function to be performed. Based on the function to be performed, the priority can then be determined by the central control unit and the transceiver. In particular, the central control unit or the transceiver can determine a priority of the user terminal based on a plurality of priority information items from a plurality of user terminals. This allows the priority to be determined depending on different user terminals and optionally, on a function to be performed by the user terminal.

In one exemplary embodiment, the method can further comprise assigning a further transceiver for a further user terminal. Assigning the further transceiver for the further user terminal allows Bluetooth connections to be distributed over different transceivers. The assignment can be carried out by the central control unit or by the transceiver.

In one exemplary embodiment the priority of the user terminal can depend on a required parameter of the Bluetooth connection between user terminal and transceiver to perform a function. This allows the Bluetooth connection to be adapted to the requirements of the user terminal. For example, a high-priority function may require a high bandwidth. For example, the required parameter can be a bandwidth, a signal strength, or a signal-to-noise ratio. For example, a user device that requires a maximum bandwidth of a Bluetooth connection to perform a function can be assigned a maximum priority.

This allows a Bluetooth connection between the user terminal and the transceiver to be given preference. Preferring the Bluetooth connection ensures that the function is able to be performed.

In one exemplary embodiment the control can comprise sending the configuration parameter to the transceiver. This allows the transceiver to receive the configuration parameter from an external unit, such as a central control unit. In particular, the described method 100 can be executed both by the transceiver and alternatively by a central control unit. The central control unit can control the transceiver by sending the configuration parameter to the transceiver. For example, the central control unit can be a central control unit of a motor vehicle.

In general the user terminal may be a device capable of communicating wirelessly. In particular, the user terminal can be a mobile user terminal, e.g. a user terminal, which is suitable for being carried by a user. For example, the user terminal device can be a user terminal (UT) or user equipment (UE) in the sense of the respective communication standards used for mobile communication. The user terminal may be, for example, a mobile phone, such as a smartphone, or another type of mobile communication device, such as a smartwatch, a laptop, a tablet computer, a pair of autonomous augmented reality glasses, etc.

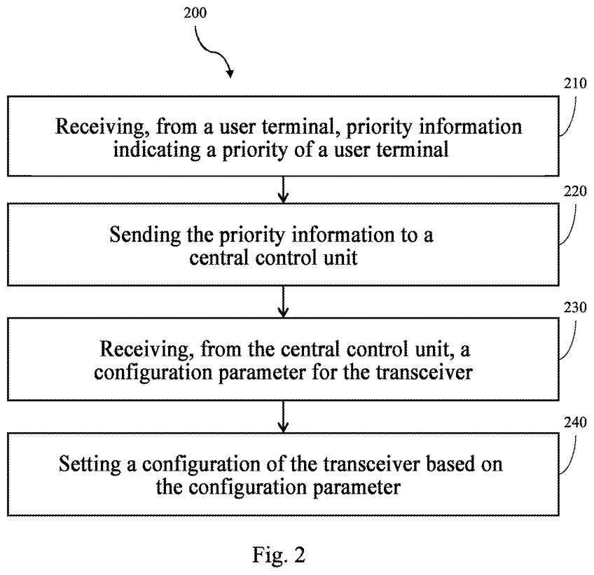

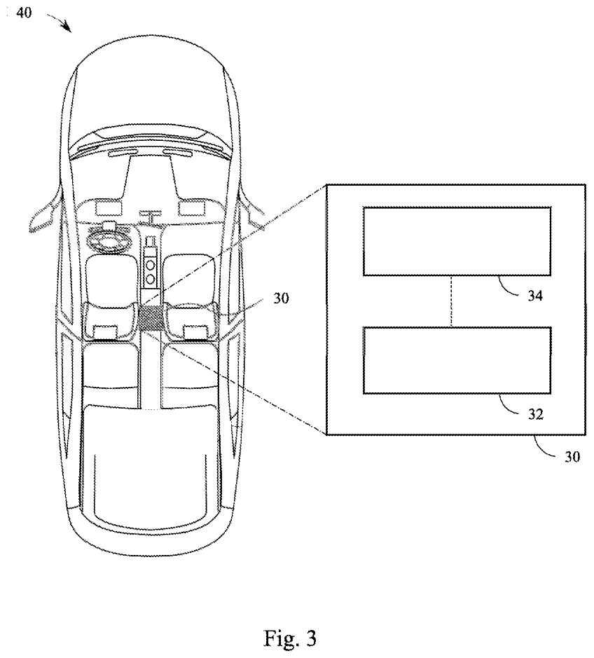

Further details and aspects are mentioned in conjunction with the exemplary embodiments described below. The exemplary embodiment shown in FIG. 1 can have one more optional additional features corresponding to one or more aspects mentioned in connection with the proposed design or with one or more exemplary embodiments described below (e.g. FIGS. 2-3).

FIG. 2 shows a schematic representation of a method 200 for a transceiver for configuring the transceiver for a Bluetooth connection. The method 200 comprises receiving 210, from a user terminal, priority information indicating a priority of a user terminal. Further, the method 200 comprises sending 220 the priority information to a central control unit. Further, the method 200 comprises receiving 230, from the central control unit, a configuration parameter for the transceiver and setting 240 a configuration of the transceiver based on the configuration parameter. This allows the transceiver to receive a configuration for a Bluetooth connection to the user terminal from the central control unit.

The method 200 is preferably carried out by a transceiver. For example, the method 200 can be carried out in conjunction with the method described in FIG. 1. The method described in FIG. 1 can then be carried out by the central control unit. The transceiver can therefore be a counterpart to a central control unit.

Further details and aspects are mentioned in conjunction with the exemplary embodiments described below and/or above. The exemplary embodiment shown in FIG. 2 can comprise one or more optional additional features corresponding to one or more aspects mentioned in connection with the proposed design or with one or more exemplary embodiments described above (e.g. FIG. 1) or below (e.g. FIGS. 3-4).

FIG. 3 illustrates a block diagram of an exemplary embodiment of a device, for example for a vehicle 40. The device 30 is designed for configuring a transceiver for a Bluetooth connection. The device 30 comprises an interface 32 for communication with a user terminal and with a central control unit or a transceiver (for example, the transceiver which carries out the method from FIG. 2). The device 30 further comprises a data processing circuit 34, which is designed for carrying out at least one of the methods described herein, for example, the method which is described with reference to FIG. 1 for the central control unit or with reference to FIG. 2 for the transceiver. Further exemplary embodiments are a vehicle 40 having a device 30.

The interface 32 shown in FIG. 3 can correspond, for example, to one or more inputs and/or one or more outputs for receiving and/or transmitting information, for example in digital bit values, based on a code, within a module, between modules, or between modules of different entities. The interface 32 may be designed, for example, to communicate with other network components via a (radio) network or a local connection network.

In exemplary embodiments, the data processing circuit 34 can be any kind of controller or processor or a programmable hardware component. For example, the data processing circuit 34 can also be implemented as software which is programmed for a corresponding hardware component. In this respect, the data processing circuit 34 can be implemented as programmable hardware with appropriately adapted software. Any type of processors, such as digital signal processors (DSPs), can be used for this. Exemplary embodiments are not restricted to a specific type of processor. Any number of processors or even a plurality of processors is conceivable for the implementation of the data processing circuit 34.

As shown in FIG. 4, the interface 32 can be coupled to the respective data processing circuit 34 of the device 30. In examples, the device 30 can be implemented by one or more processing units, one or more processing devices, any means for processing, such as a processor, a computer or a programmable hardware component, which can be operated with appropriately adapted software. Likewise, the described functions of the data processing circuit 34 can also be implemented in software, which is then executed on one or more programmable hardware components. Such hardware components can be a multi-purpose processor, a digital signal processor (DSP), a microcontroller, etc. The data processing circuit 34 may be capable of controlling the interface 32, so that any data transmission taking place via the interface 32 and/or any interaction in which the interface 32 can be involved can be controlled by the data processing circuit 34.

In one embodiment, the device 30 may comprise a memory and at least one data processing circuit 34, which is functionally coupled to the memory and is configured to carry out one of the methods described above.

In examples, the interface 32 may correspond to any means of obtaining, receiving, transmitting or providing analog or digital signals or information, such as any port, contact, pin, register, input port, output port, conductor, track, etc., which allows a signal or information to be provided or received. The interface 32 can be wireless or wired and can be configured so as to be able to communicate with other internal or external components, e.g. to transmit or receive signals or information.

In at least some exemplary embodiments the vehicle 40 can correspond, for example, to an agricultural vehicle, a water-borne vehicle, an aircraft, a railway vehicle, a road vehicle, a car, a bus, a motorcycle, an all-terrain vehicle, a motor vehicle or a heavy goods vehicle. The device 30 can be, for example, a control device or a part of a control device of the vehicle 40.

Further details and aspects are mentioned in conjunction with the exemplary embodiments described above. The exemplary embodiment shown in FIG. 3 can have one or more optional additional features corresponding to one or more aspects mentioned in connection with the proposed design or with one or more exemplary embodiments described above (e.g. FIGS. 1-2).

Further exemplary embodiments are computer programs for carrying out any of the methods described herein, when the computer program is executed on computer, a processor or a programmable hardware component. Depending on the specific implementation requirements, exemplary embodiments of the disclosure can be implemented either in hardware or in software. The implementation can be carried out by using a digital storage medium, such as a floppy disk, a DVD, a Blu-Ray disc, a CD, a ROM, a PROM, an EPROM, an EEPROM or Flash memory, a hard disk or other magnetic or optical storage, on which electronically readable control signals are stored, which can interact or interact with a programmable hardware component, in such a way that the respective method is carried out.

A programmable hardware component can be formed by a processor, a computer processor (CPU=Central Processing Unit), a graphics processing unit (GPU=Graphics Processing Unit), a computer, a computer system, an application-specific integrated circuit (ASIC), an integrated circuit (IC), a single-chip system (SOC=System-on-Chip), a programmable logic element or a field-programmable gate array (FPGA) with a microprocessor.

The digital storage medium can therefore be machine- or computer-readable. Some exemplary embodiments thus comprise a data carrier, which has electronically readable control signals that are capable of interacting with a programmable computer system or programmable hardware component, in such a way that one of the methods described herein is carried out. One exemplary embodiment therefore is a data carrier (or a digital storage medium or a computer-readable medium), on which the program for carrying out one of the methods described herein is recorded.

In general, exemplary embodiments of the present disclosure can be implemented as software, firmware, computer program or computer program product with a program code or as data, wherein the program code is, or the data are, effective in terms of carrying out one of the methods if the program is running on a processor or a programmable hardware component. The program code or the data can also be stored, for example, on a machine-readable medium or data carrier. The program code or the data can exist in the form of source code, machine code or byte code, among other things, as well as other intermediate code.

Functions of various elements shown in the figures, including each as functional blocks designated as “means”, “means for providing a signal”, “means for generating a signal”, etc., can be implemented in the form of dedicated hardware, e.g. “of a signal provider”, “of a signal processing unit”, “of a processor”, “of a controller”, etc. and as hardware capable of executing software in connection with associated software. When being provided by a processor, the functions can be provided by a single dedicated processor, by a single jointly used processor or by a plurality of individual processors some or all of which may be jointly used. However, the term “processor” or “controller” is by far not limited exclusively to executing software-capable hardware but can comprise digital signal processor (DSP) hardware, a network processor, application-specific integrated circuit (ASIC), field-programmable logic array (FPGA=field-programmable gate array), read-only memory (ROM) for storing software, random-access memory (RAM) and non-volatile storage device. Other hardware, customary and/or customer-specific, may also be included.

The examples described above only represent an illustration of the principles of the present disclosure. It is implicit that modifications and variations of the arrangements and details described herein will be apparent to other persons skilled in the art. It is therefore intended that the disclosure be limited only by the scope of protection of the following patent claims and not by the specific details, which have been presented herein on the basis of the description and explanation of the exemplary embodiments.

### LIST OF REFERENCE SIGNS

30 device
32 interface
34 data processing circuit
40 vehicle
100 method for configuring a transceiver
110 receiving priority information
120 determining a transceiver for communication
130 determining a configuration parameter
140 controlling a configuration of the transceiver
200 method for a transceiver
210 receiving priority information
220 sending the priority information
230 receiving a configuration parameter
240 setting a configuration

1.-10. (canceled)

11. A method for configuring one of a plurality of transceivers for a Bluetooth connection, comprising:
receiving priority information indicating a priority of a user terminal;
determining, based on the priority information, a transceiver of the plurality of transceivers for communicating with the user terminal using a Bluetooth connection;
determining a configuration parameter for the transceiver; and
controlling a configuration of the transceiver based on the configuration parameter.

12. The method as claimed in claim 11, wherein the determination of the configuration parameter comprises at least one of:
terminating an active Bluetooth connection between the transceiver and a further user terminal with a lower priority than the user terminal;
preventing a Bluetooth connection from being set up between the further user terminal and the transceiver;
terminating an active Bluetooth connection between the user terminal and a further transceiver; and
maintaining or establishing a Bluetooth connection between the transceiver and the user terminal.

13. The method as claimed in claim 12, also comprising determining the priority of the user terminal based on the priority information.

14. The method as claimed in claim 13, also comprising assigning the further transceiver for a further user terminal.

15. The method as claimed in claim 14, wherein the priority of the user terminal depends on a required parameter of the Bluetooth connection between user terminal and the transceiver for performing a function.

16. The method as claimed in claim 15, wherein the control comprises sending the configuration parameter to the transceiver.

17. The method of claim 11 wherein the method is executed on a computer, a processor, or a programmable hardware component.

18. A method for configuring one of a plurality of transceivers for a Bluetooth connection, comprising:
receiving, from a user terminal, priority information indicating a priority of a user terminal;
sending the priority information to a central control unit;
receiving, from the central control unit, a configuration parameter for the one transceiver of the plurality of transceivers; and
setting a configuration of the one transceiver based on the configuration parameter.

19. The method of claim 18 wherein the method is executed on a computer, a processor or a programmable hardware component.

20. The method as claimed in claim 18, wherein the received configuration parameter is determined by:
terminating an active Bluetooth connection between the one transceiver and a further user terminal with a lower priority than the user terminal;
preventing a Bluetooth connection from being set up between the further user terminal and the one transceiver;
terminating an active Bluetooth connection between the user terminal and a further transceiver; and
maintaining or establishing a Bluetooth connection between the one transceiver and the user terminal.

21. The method as claimed in claim 20, also comprising determining the priority of the user terminal based on the received priority information.

22. The method as claimed in claim 21, also comprising assigning the further transceiver for a further user terminal.

23. The method as claimed in claim 12, wherein the priority of the user terminal depends on a required parameter of the Bluetooth connection between user terminal and the one transceiver for performing a function.

24. A vehicle comprising:
a plurality of transceivers configured to communicate with a user terminal; and
a device for configuring one of the plurality of transceivers for a Bluetooth connection, the device including:
an interface for communication with at least one of the user terminal, a central control unit or one of the plurality of transceivers; and
a data processing circuit configured to:
receive priority information indicating a priority of a user terminal;
determine, based on the priority information, a determined transceiver of the plurality of transceivers for communicating with the user terminal using a Bluetooth connection;
determine a configuration parameter for the determined transceiver; and
control a configuration of the determined transceiver based on the configuration parameter.

25. The vehicle of claim 24 wherein the determination of the configuration parameter comprises at least one of:
terminating an active Bluetooth connection between the one transceiver and a further user terminal with a lower priority than the user terminal;
preventing a Bluetooth connection from being set up between the further user terminal and the one transceiver;
terminating an active Bluetooth connection between the user terminal and a further transceiver; and
maintaining or establishing a Bluetooth connection between the one transceiver and the user terminal.

26. The vehicle of claim 25 wherein the data processing circuit is further configured to determine the priority of the user terminal based on the received priority information.

27. The vehicle of claim 26 wherein the data processing circuit is further configured to assign the further transceiver for a further user terminal.

28. The vehicle of claim 27 wherein the priority of the user terminal depends on a required parameter of the Bluetooth connection between user terminal and the one transceiver for performing a function.

29. The vehicle of claim 28 wherein the user terminal is a mobile phone.
